(19) United States
(12) Patent Application Publication
(10) Pub. No.: US 2020/0398295 A1
(43) Pub. Date: Dec. 24, 2020

(54) PORTABLE DISTRIBUTOR WITH SEVERAL PUMPS AND A ROTARY DISTRIBUTION HEAD

(71) Applicant: LABORATOIRES CLARINS, Paris (FR)

(72) Inventor: Antoine DE BEAUMESNIL, Saint-Prix (FR)

(21) Appl. No.: 16/978,756

(22) PCT Filed: Mar. 4, 2019
(86) PCT No.: PCT/EP2019/055330

§ 371 Date: Sep. 7, 2020

(30) Foreign Application Priority Data
Mar. 5, 2018 (FR) 1851890

(51) Int. Cl. B05B 11/00; A45D 34/00

(52) U.S. Cl. CPC B05B 11/00416; A45D 34/00; A45D 2200/055; B05B 11/3047; B05B 11/3015; B05B 11/3052

(57) ABSTRACT

A portable distributor (10) of several fluid or pasty products comprises: a body (12); a distribution head (22) which can be rotated and which is not free to translate relative to the body (12) around a reference axis (100); at least two pumps (16A, 16B, 16C) with nozzles (54A, 54B, 54C); and a kinematic connection (24) between the distribution head (22), and the nozzles of the two pumps, to transform the rotation of the distribution head (22) into a translational motion without rotation of the pumps' nozzles (54A, 54B, 54C). The kinematic connection (24) comprises a plunger (82) connected to the body by a straight line linkage (58, 98), where the plunger (82) comprises distribution channels (96A, 96B, 96C) to channel the fluids being ejected from the nozzles (54A, 54B, 54C) towards the distribution aperture (66).

### TECHNICAL FIELD OF THE INVENTION

The invention relates to a portable distributor of several fluid products parallel to constitute a blend, for example of several cosmetic care, make-up or perfumery products, and/or of several pharmaceutical products. The expression “fluid products” will include liquid products, and creams and products which are pasty and sufficiently malleable to be distributed using pumps.

### STATE OF THE PRIOR ART

In document FR2822655 a cosmetic product distributor is described comprising: a distributor body, a distribution head which can be rotated relative to the distribution body around a reference axis of the distributor, where the distribution head comprises a distribution aperture, and a distribution pump having a tubular nozzle defining an ejection axis which is the same as the reference axis of the distributor, and where the nozzle is free to translate relative to the distributor body parallel to the ejection axis. The distribution head has two pins which can be engaged in two grooves forming spiral tracks of the distributor body. To distribute the product the user rotates the distribution head, which follows a helical trajectory and presses into the nozzle to deliver a dose of product.

The head is returned to the starting position by rotating the head in the reverse direction with the force of the spring of the pump which pushes back the nozzle. To enable this motion the pitch of the spiral must be chosen so that it guarantees that the motion transformation mechanism is reversible. This means that an axial force applied to the distribution head parallel to the distributor's reference axis causes the distribution head to swivel and be pressed in. It is not therefore possible to guarantee, under uncontrolled storage conditions, for example in a travelling toilet-case, that the product will not be ejected in an untimely manner.

Furthermore, the direct kinematic connection between the distribution head and the distributor's body, which is implemented by the pins and the tracks, requires parts of relatively complex shape, with many undercuts, the manufacture by moulding of which requires slider moulds.

The volume occupied by this kinematic connection also requires a certain height of the distribution head, which is dependent on the nozzle's working stroke.

Without specific protective measures, the alternating motion of the distribution head relative to the distribution body can lead to foreign matter penetrating through the variable gap between the distribution head and the distributor body. This foreign matter can compromise the cleanliness, or the operation, of the distributor.

Finally, this distributor requires that the axis of rotation of the distribution head is aligned with the nozzle of the pump, and is not suitable either for a distributor the nozzle of which is out-of-line, nor a distributor which must actuate several pumps.

In document EP3241459A1 a distributor of one or more fluid or pasty products is described and illustrated, comprising a distributor body, a distribution head which is fixed relative to the distributor body, comprising two distribution apertures, and a pump assembly comprising two pumps, where each is connected to one of the distribution apertures, and each has a tubular nozzle defining an ejection axis passing through the associated distribution aperture, where the ejection axes are parallel to a reference axis of the distributor, and separated from one another, and where the nozzles are free to translate relative to the distributor body parallel to the ejection axes. A rotary intermediate ring is interposed between the head and body of the distributor. The intermediate ring can be rotated and is not free to translate relative to the distributor body around the distributor's reference axis. A kinematic connection between the rotary intermediate ring and the two nozzles enables a rotational motion without translation of the rotary ring relative to the distributor body around the reference axis of the distributor to be transformed into a translational motion without rotation of the nozzle of the first pump and of the nozzle of the second pump relative to the distributor body, parallel to the distributor's reference axis. This kinematic connection comprises a plunger interposed between the pump assembly and the rotary intermediate ring, where the plunger is connected to the distributor body by a straight line linkage which can guide a translational motion without the plunger rotating relative to the distributor body. The plunger can press on the nozzles of the two pumps when the intermediate ring rotates relative to the distributor body around the distributor's reference axis. The plunger comprises two parallel distribution channels, each one designed to channel the fluid being ejected from one of the nozzles towards the associated distribution aperture. The distribution head forms a flared cup which enables the user to blend the two fluids to obtain the desired end product. The ergonomics of using such a distributor are not totally satisfactory, since the user must hold the body or head of the distributor with one hand, and with the other must access the intermediate ring, which is located under the flared head.

### DESCRIPTION OF THE INVENTION

The invention seeks to remedy at least some of the disadvantages of the state of the art, and to propose a distributor with several pumps which is easy to manufacture and use.

To accomplish this, according to a first aspect of the invention, a distributor of one or more fluid or pasty products is proposed, comprising:
a distributor body;
a distribution head which can be rotated and which is not free to translate relative to the distributor body around a reference axis of the distributor, and which is not free to translate relative to the distributor body, where the distribution head comprises at least one distribution aperture, preferably aligned with the distributor's reference axis;
a pump assembly comprising at least one first pump and at least one second pump, where the first pump comprises a tubular nozzle defining a first ejection axis which is fixed relative to the distributor body and parallel to the reference axis of the distributor, where the nozzle of the first pump is free to translate relative to the distributor body parallel to the first ejection axis, where the second pump comprises a tubular nozzle defining a second ejection axis which is fixed relative to the distributor body and parallel to the first ejection axis, and where the nozzle of the second pump is free to translate relative to the distributor body parallel to the second ejection axis; and
a kinematic connection between the distribution head and the nozzles of the first pump and of the second pump, to transform a rotary motion without translation of the distribution head relative to the distributor body around the reference axis of the distributor into a translational motion without rotation of the nozzles of the first pump and of the second pump relative to the distributor body parallel to the distributor's reference axis, where the kinematic connection comprises a plunger interposed between the pump assembly and the distribution head, where the plunger is connected to the distributor body by a straight line linkage which can guide a translational motion without rotation of the plunger relative to the distributor body, where the plunger is able to press on the nozzle of the first pump and on the nozzle of the second pump when the distribution head rotates relative to the distributor body around the distributor's reference axis, where the plunger comprises at least a first distribution channel, to channel a first fluid being ejected from the nozzle of the first pump towards the distribution aperture, and a second distribution channel, to channel a fluid being ejected from the nozzle of the second pump to the distribution aperture.

The distribution head constitutes both the distributor's actuation device and the distribution device, incorporating the distribution aperture. Use of the distributor is therefore particularly ergonomic. The fact that the distribution head is not free to translate means that its height can be quite low, and this also simplifies the shapes guiding the rotary motion of the distribution head relative to the distributor body. The simplified shapes can thus be obtained by an injection moulding process, in a mould the parts of which are free to translate, but not free to rotate, relative to one another, by an axial motion preferably parallel to the reference axis.

The distributor body can be made of glass or of a moulded material.

According to one implementation, the kinematic connection between the distribution head and the nozzle comprises an annular guide track positioned at a constant distance from the distributor's reference axis, having one or more undulations, in an axial direction parallel to the distributor's reference axis, and an assembly of one or more sliding surfaces cooperating with the annular guide track, where the annular guide track and the assembly of one or more sliding surfaces are designed such that rotation of the distribution head around the distributor's reference axis causes a relative translation between the annular guide track and the assembly of one or more sliding surfaces parallel to the distributor's reference axis, combined with a relative rotation between the annular guide track and the assembly of one or more sliding surfaces around the distributor's reference axis. The assembly of one or more sliding surfaces is preferably formed by a group open in an axial direction, where the annular guide track enters into the groove, in contact with a rippled bottom of the groove. The groove may possibly also help to guide the distribution head around the reference axis.

According to one particularly advantageous implementation, the annular guide track is continuous and enables a full revolution of the distribution head to be made around the distributor's reference axis. This continuity enables the user to use the distributor without being concerned with any particular initial position. The position of the pump assembly and of the kinematic connection between the distribution head and the nozzle reached after one revolution is preferably identical to the starting position, and corresponds to a whole number of pump cycles, where this number can be greater than or equal to one.

According to a preferred implementation, the annular guide track and the assembly of one or more sliding surfaces are positioned such that the distribution head can rotate around the distributor's reference axis in a direct direction and in a retrograde direction, preferably over more than one revolution. The desired transformation of the rotational motion without translation of the distribution head into a translational motion without rotation of the nozzle is thus obtained in both rotational directions of the distribution head.

According to one implementation, the distributor body comprises:
a cylindrical guide surface which is radially turned towards the distributor's reference axis, and positioned level with a cylindrical guide surface of the distribution head to guide the distribution head rotationally around the distributor's reference axis relative to the distributor body; and/or
a cylindrical guide surface which is radially turned away from the distributor's reference axis, and positioned level with a cylindrical guide surface of the distribution head to guide the distribution head rotationally around the distributor's reference axis relative to the distributor's body.

These guide surfaces contribute to the rotational guidance of the distribution head relative to the distributor's body.

According to one implementation, the distributor's body comprises:
an annular guide surface, which is preferably flat, axially turned away from the distribution aperture, level with an additional guide surface of the distribution head and/or
an annular guide surface, which is preferably flat, axially turned towards the distribution aperture, level with an additional guide surface of the distribution head.

These annular guide surfaces contribute to the axial guidance of the distribution head relative to the distributor's body.

Depending on the type of distributed product, the distribution aperture can open on to a flat, concave or convex surface of the distribution head. A concave surface forming a basin will be preferred, in particular if the distributed product is relatively fluid, or if it is desired that the user should be able to blend the distributed product or products before they are applied.

The plunger is a device separate from the distribution head and from the distributor's body. The plunger preferably consists of at least two parts which are securely coupled, each of which is preferably obtained by moulding in a mould, the parts of which are free to translate relative to one another parallel to the reference axis. The desired kinematics are therefore obtained with simple geometries, and therefore simple tools.

If the first ejection axis is the same as the reference axis, and as the distribution aperture's axis, the first distribution channel has an essentially axial alignment. If the first ejection axis is separated from the reference axis and from the distribution aperture's axis, the first distribution channel comprises a radial alignment segment relative to the distributor's reference axis and to the first ejection axis.

There may be a portion of channel which can be extended in a direction parallel to the reference axis, to channel the first fluid and the second fluid between the first distribution channel, the second distribution channel and the distribution aperture. The extensible channel portion enables the distance variations between the distribution channels and the distribution aperture to be controlled, when the distribution head rotates around the reference axis.

The extensible channel portion of the first channel and the extensible channel portion of the second channel preferably have a common outer casing. According to a first variant implementation, the common outer casing comprises two cylindrical segments which can slide within one another parallel to the distributor's reference axis, and can rotate relative to one another around the distributor's reference axis, where one of the two cylindrical segments is fixed relative to the distribution head, and where the other of the two cylindrical segments is fixed relative to the plunger. According to a second variant implementation, the common outer casing is a deformable wall, for example an accordion wall, having a first fixed end which is not free to translate relative to the distribution head, and a second fixed end which is not free to translate relative to the plunger. The common outer casing preferably comprises an annular sealing device pressing against a gasket seat, and able, relative to the seal seat when the distribution head rotates relative to the distributor body around the reference axis.

The nozzles of the two pumps preferably have identical working strokes. It is possible, however, to envisage that one of the two pumps may have a working stroke which is shorter than the other, in which case the plunger may have a dead stroke before the plunger presses on to the nozzle of the pump which has the shorter working stroke.

Both pumps can possibly be immersed in the same reservoir containing a fluid or pasty product, to deliver a substantial volume of product, with a short stroke of the plunger.

Alternatively, both pumps can be immersed in separate reservoirs, to deliver separate products, which are blended when they are distributed, in the distribution aperture, or slightly before this point. According to one implementation, the distributor body comprises a wall delimiting a peripheral reservoir in which a pump body of one of the first and second pumps opens, where the other of the first and second pumps comprises a pump body which is immersed in another reservoir preferably held inside the peripheral reservoir. The wall of the reservoir of the distributor's body can be opaque or transparent. Similarly, the inner reservoir can be opaque or transparent. The transparency of the walls in particular enables the levels of fluid contained in the reservoirs to be shown.

According to one implementation, one of the ejection axes is the same as the distributor's reference axis, where the other is displaced, which however requires precautions when guiding the plunger, which may be subject to stress from forces the resultant force of which is not in the reference axis, generating a parasitic torque.

According to another implementation, both ejection axes are displaced relative to the reference axis. The three axes can be coplanar to optimise the direction of the resulting force on the plunger, or they may not be.

According to a particularly advantageous implementation, the pump assembly comprises at least one third pump, comprising a tubular nozzle defining a third ejection axis which is fixed relative to the distributor body, and parallel to the first ejection axis, where the nozzle of the third pump is free to translate relative to the distributor body parallel to the third ejection axis, where the plunger is able to press on to the nozzle of the third pump when the distribution head turns relative to the distributor body around the distributor's reference axis, and comprising a third distribution channel to channel a fluid being ejected from the nozzle of the third pump towards the distribution aperture. The three ejection axes can be coplanar, or form an isosceles triangle, or an equilateral triangle, to minimise encumbrance. One of the three ejection axes may possibly be the same as the reference axis. The three pumps can be immersed in three separate chambers, to pump three separate fluids corresponding, if applicable, to three separate products which are to be blended. Alternatively, two of the three pumps can be immersed in a common chamber, which enables, with a given stroke of the plunger, very different proportions to be obtained for the fluid delivered by a single pump and for the fluid delivered by two pumps in parallel.

The distributor body preferably comprises one or more walls delimiting a reservoir with a fixed volume into which opens at least one pump body of a pump in the pump assembly, where the wall or walls preferably comprise one or more outer walls of the distributor body.

The distributor preferably comprises at least one reservoir of variable volume comprising at least one moving wall, in which a pump body of a pump in the pump assembly is immersed. According to one implementation, the reservoir of variable volume is formed by a cylindrical drum closed by a piston. Alternatively, the reservoir of variable volume is formed by a deformable pocket.

If the distributor comprises several reservoirs, all of them can be fixed-volume or variable-volume, or some of them can be fixed-volume while others are variable-volume.

According to a second aspect of the invention, the latter relates to a distributor of one or more fluid or pasty products comprising:
a distributor body;
a distribution head which can be rotated relative to the distributor body around a reference axis of the distributor, with or without translation, where the distribution head comprises at least one distribution aperture;
a pump assembly comprising at least one first pump comprising a tubular nozzle defining a first ejection axis which is fixed relative to the distributor body, parallel to the reference axis of the distributor and separated from the reference axis of the distributor, where the nozzle of the first pump is free to translate relative to the distributor body parallel to the first ejection axis;
a kinematic connection between the distribution head and the nozzle, to transform a rotating motion of the distribution head relative to the distributor's body around the reference axis of the distributor into a translational motion without rotation of the nozzle relative to the distributor body, parallel to the distributor's reference axis.

It is thus possible to displace the axis of the nozzle relative to the reference axis.

The distribution axis is preferably aligned with the reference axis.

According to one particularly advantageous implementation, the distributor also comprises a plunger pressing on the nozzle of the first pump, and comprising a first distribution channel to channel the first fluid being ejected from the nozzle of the first pump towards the distribution aperture. The first distribution channel preferably has a radial alignment relative to the reference axis of the distributor and to the first ejection axis.

According to this second aspect of the invention, the distributor may possibly have all or some of the characteristics of the distributor according to the first aspect of the invention, with the same advantages.

According to a third aspect of the invention, the latter relates to a distributor of one or more fluid or pasty products comprising:
a distributor body;
a distribution head which can be rotated relative to the distributor body around a reference axis of the distributor, with or without translation, where the distribution head comprises at least one distribution aperture;
a pump assembly comprising at least one first pump comprising a tubular nozzle defining a first ejection axis which is fixed relative to the distributor body, parallel to the reference axis of the distributor, where the nozzle of the first pump is free to translate relative to the distributor body parallel to the first ejection axis;
a plunger pressing on the nozzle of the first pump, and comprising a first distribution channel to channel the first fluid being ejected from the nozzle of the first pump towards the distribution aperture.
a straight line linkage between the distributor body and the plunger to guide a translational motion without rotation of the plunger relative to the distributor's body;
a kinematic connection between the distribution head and the plunger, to transform a rotating motion of the distribution head relative to the distributor's body around the reference axis of the distributor, with or without translation, into a translational motion without rotation of the nozzle relative to the distributor body, parallel to the distributor's reference axis.

The plunger allows the translational motion of the nozzle or nozzles to be controlled, and enables parasitic forces perpendicular to the reference axis to be prevented from being transmitted to the nozzle.

According to this third aspect of the invention, the distributor may possibly have all or some of the characteristics of the distributors according to the first aspect of the invention or the second aspect of the invention, with the same advantages.

### BRIEF DESCRIPTION OF THE FIGURES

Other characteristics and advantages of the invention will be seen clearly on reading the description below, with reference to the appended figures, which illustrate:

FIG. 1, an exploded view from a first viewing angle of a distributor according to one implementation of the invention;

FIG. 2, an exploded view from another viewing angle of the distributor of FIG. 1;

FIG. 3, a cross-section view, using a cross-section III-III illustrated in FIG. 5, of the distributor of FIG. 1;

FIG. 4, a cross-section view, using a cross-section IV-IV illustrated in FIG. 5, of the distributor of FIG. 1;

FIG. 5, a cross-section view, using a cross-section V-V illustrated in FIG. 3, of the distributor of FIG. 1;

FIG. 6, an exploded view of a sub-assembly of the distributor of FIG. 1;

FIG. 7, an exploded view of the sub-assembly of FIG. 6, from another viewing angle;

FIG. 8, a cross-section view of a detail of a variant implementation of a extensible channel portion of the distributor of FIG. 1.

For greater clarity, identical or similar elements are identified by identical reference signs in all the figures.

### DETAILED DESCRIPTION OF IMPLEMENTATIONS

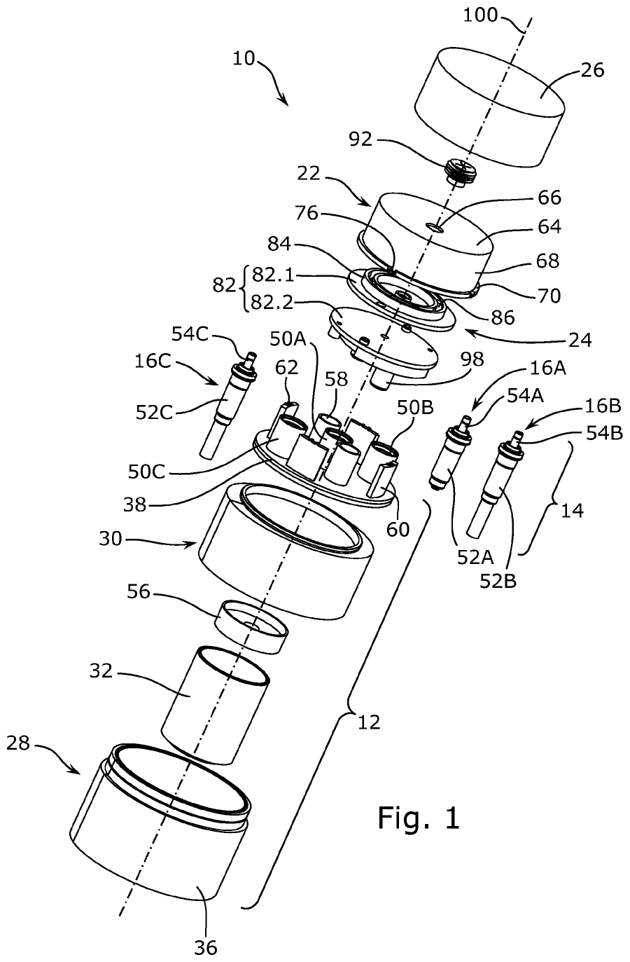

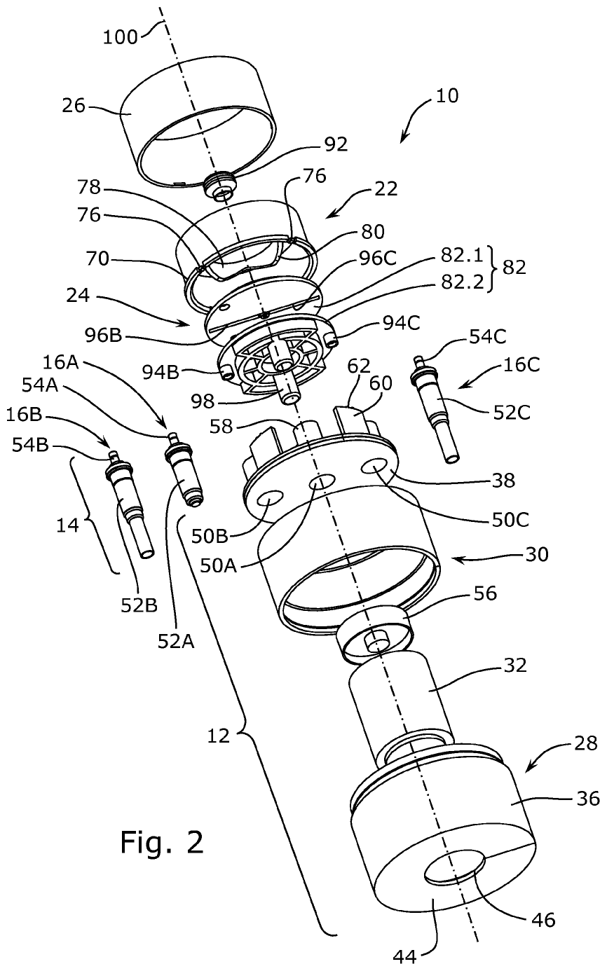

With reference to FIGS. 1 and 2, a portable distributor 10 according to an implementation of the invention comprises a distributor body 12, a pump assembly 14 comprising three parallel pumps 16A, 16B, 16C, a distribution head 22 covering pump assembly 14, which is free to rotate relative to distributor body 12 around an axis of revolution 100, which is also a reference axis of distributor 10, a kinematic connection 24 between distribution head 22 and pump assembly 14, and an optional outer cover 26.

In the remainder of the description it will be considered, arbitrarily, that cover 26 is positioned “above” body 12 of the distributor, and that reference axis 100 of the distributor is aligned vertically. The term “upper” will thus be used to designate that which is turned “upwards”, or that which is “above”, and the term “lower” to designate that which is turned “downwards”, or that which is “below”.

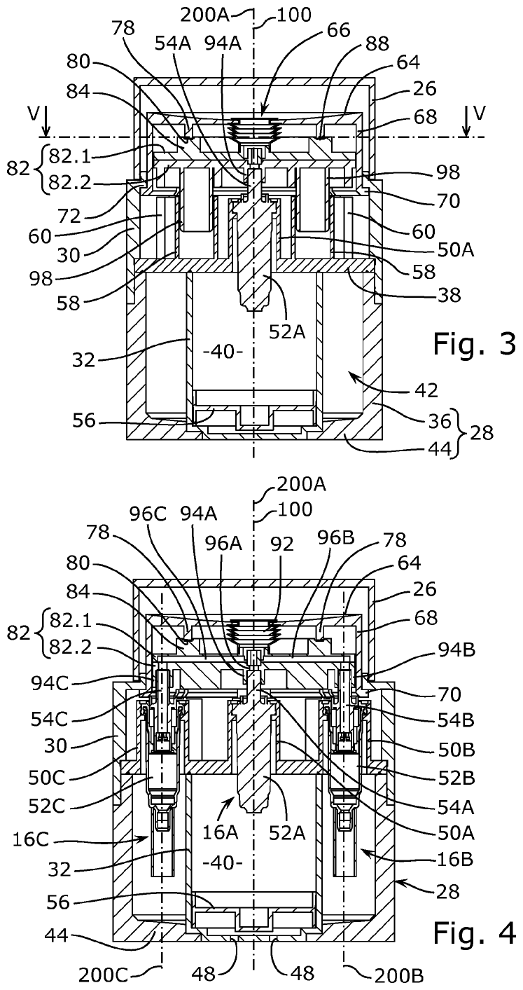

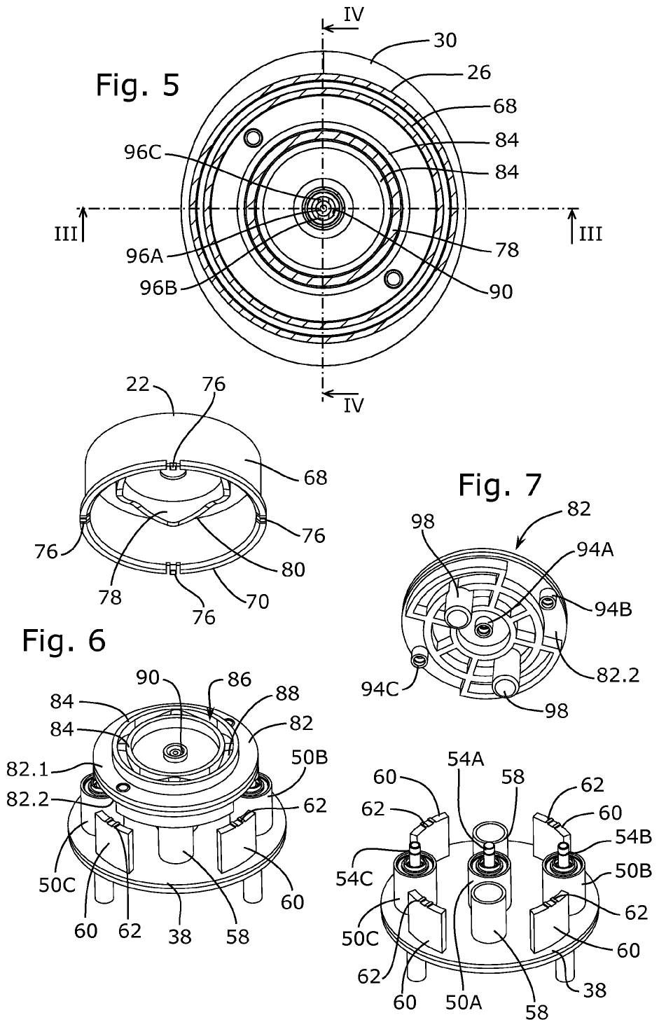

As illustrated in particular in FIGS. 3 and 4, body 12 of distributor 10, which has a cylindrical shape with an oval or elliptical base centred on reference axis 100 of the distributor, comprises a base 28, a hoop 30 added on to the base, a drum 32 held in a chamber formed by an outer cylindrical wall 36 of the base, and a support bed 38 clamped between hoop 30 and base 28. Bed 38 is pressing against an upper annular edge of base 28 with interposition of a sealing joint, and against an upper annular edge of drum 32 with interposition of another sealing joint, so as to delimit two reservoirs 40, 42, which are separate and not communicating, one 40 inside drum 32, the other 42 in the portion of the chamber which is not occupied by drum 32. Base 28 comprises a bottom 44 having a central cylindrical opening 46, in which is recessed the axial end of drum 32 opposite bed 38, where this axial end has one or more openings 48 made in it (FIG. 4).

Bed 38 has three receiving shafts 50A, 50B, 50C, each to receive one of pumps 16A, 16B, 16C of pump assembly 14. Each pump 16A, 16B, 16C, comprises a pump body 52A, 52B, 52C, snapped into associated shaft 50A, 50B, 50C, an internal mechanism of a known type, and a tubular nozzle 54A, 54B, 54C, free to rotate relative to pump body 52A, 52B, 52C between a resting position and a pressed-in position, in order, simultaneously, to actuate the mechanism of associated pump 16A, 16B, 16C, and to deliver through its outlet aperture a dose of the pumped fluid product. The axis of translation of each nozzle 200A, 200C, 200C, referred to in what follows as the “ejection axis”, is parallel to reference axis 100 of distributor 10. Two of the three pumps, 16B, 16C, open in reservoir 42 positioned outside the drum, where the third 16A, which is central, opens in drum 32. Optionally, seals can be positioned in each shaft 50A, 50B, 50C to provide or to improve the seal around associated pump body 52A, 52B, 52C. Thus, reservoir 42 positioned outside drum 32 has a constant volume and is completely sealed relative to the exterior, and the only communication with the exterior occurs through pumps 16B, 16C, which are of the air return type. Drum 32, for its part, is fitted with a sliding piston 56, separating in sealed fashion reservoir 40, which is of variable volume, from a volume connected externally by openings 48. Pump 16A, immersed in drum 32, is a pump without air return. In this implementation, ejection axes 200A, 200B, 200C are positioned in a common plane which contains reference axis 100 of distributor 10.

Bed 38 also has two guidance tubes 58 and four axial stops 60, which protrude towards distribution head 22, and each has a pair of indexing pins 62.

Distribution head 22 has a bottom 64 with a distribution aperture 66 centred on reference axis 100, and a cylindrical outer wall 68 with, at its free end, a guidance collar 70, which is inserted in a reserved annular space, axially delimited by axial stops 60 of bed 38 and by a flat annular shoulder 72 formed at the free end of hoop 30, and radially by a cylindrical guiding surface formed by the inner wall of hoop 30, to implement rotational guidance without translation of distribution head 22 relative to body 12 of distributor 10 around reference axis 100. Collar 70 has four notches, each of which acts as a recess for a tongue 76.

Bottom 64 of distribution head 22 has an outer face, turned away from bed 38, shaped like a basin centred on distribution aperture 66, and an inner face, with a cylindrical inner skirt 78 protruding towards bed 38 (FIG. 6). This skirt 78 has an end edge, positioned at a constant distance from the distributor's reference axis, which forms an annular guide track 80 and has one or more undulations, in this instance four such, in an axial direction parallel to reference axis 100 of distributor 10.

Between bottom 64 of distribution head 22 and bed 38 of body 12 of distributor 10 a plunger 82 is positioned which constitutes, with annular guide track 80, the kinematic connection enabling the rotary motion of distribution head 22 to be transformed into a translational motion of nozzles 54A, 54B, 54C.

Plunger 82 consists of two disc-shaped parts 82.1, 82.2, attached to one another by bonding or any other appropriate means. Plunger 82 is positioned inside outer wall 68 of distribution head 22, and has a circular outer edge in sliding contact with the inner face of outer wall 68.

As illustrated more specifically in FIG. 6, plunger 82 comprises, on its upper face turned towards to bottom 64 of distribution head 22, two coaxial cylindrical walls 84 between which a groove 86 is formed, the bottom 88 of which has undulations which, in an angular position of reference of distribution head 22 relative to plunger 82, are complementary to the undulations of annular guide track 80. Groove 86 is formed so as to enable inner skirt 78 of distribution head 22 to be inserted between the two coaxial walls 84, with a small gap, or in sliding contact.

On the upper face of the plunger an outlet aperture 90 is formed, positioned opposite distribution aperture 66 of distribution head 22, where the two apertures 66, 90 are aligned with reference axis 100 of distributor 10. A bellows sleeve 92 forms a channel of variable length between the two apertures 66, 90. Bellows sleeve 92 can, if applicable, form a valve.

As illustrated in FIG. 7, plunger 82 comprises, on its inner face turned towards bed 38, two guidance tubes 98 which are inserted in guidance tubes 58 of bed 38 to form a telescopic connection to guide the translation of plunger 82 relative to bed 38 parallel to reference axis 100 of distributor 10.

On the lower face of plunger 82 tubular sleeves 94A, 94B, 94C are formed, in which nozzles 54A, 54B, 54C are inserted, preferably tightly adjusted. Distribution channels 96A, 96B, 96C are made in the plunger to connect nozzles 54A, 54B, 56C to outlet aperture 90, in this instance a purely axial channel 96A for pump 16A aligned with reference axis 100 of distributor 10, and channels 96B, 96C extending radially for the other two pumps 16B, 16C.

Distributor 10 functions as follows:

In an angular position of reference of distribution head 22 relative to body 12 of distributor 10, the contact between guide track 80 and bottom 88 of groove 86 is a surface contact, and the distance between the upper face of plunger 82 and bed 38 is at its maximum. Nozzles 54A, 54B, 54C of the pumps are at their top dead centre, and the springs (not represented) integrated in each pump 16A, 16B, 16C push nozzles 54A, 54B, 54C and, through them, plunger 82, parallel to reference axis 100, such that collar 70 of distribution head 22 is pressing axially against shoulder 72 formed by hoop 30 of body 12 of distributor 10. This position is therefore an equilibrium position. Each of tongues 76 is held by one of the pairs of pins 62, such that this position is an indexed position.

To obtain distribution of a dose of product the user rotates distribution head 22 relative to body 12 of distributor 10 around reference axis 100, from the indexed start position to the next indexed position defined by tongues 76 and pairs of indexing pins 62, over a quarter turn. The elastic snapping of tongues 76 between pins 62 when the new indexed position is attained can be perceived by the user by their sense of touch or by hearing.

The rotation of distribution head 22 relative to plunger 82 requires that there is a relative translational motion between guide track 80 and bottom 88 of guidance groove 86. Over approximately the first half of the angular stroke, therefore over one eighth of a revolution, the relative motion of guide track 80 and of bottom 88 of guidance groove 86 causes, by a cam effect, an axial motion of plunger 82 towards bed 38, pushing nozzles 54A, 54B, 54C against the force of the springs integrated in the mechanisms of pumps 16A, 16B, 16C. The amplitude of this motion is such that nozzles 54A, 54B, 54C cover at least a portion of their working translation stroke, which is sufficient to activate a pump cycle. The fluid of central reservoir 40, delivered by central pump 16A, and the fluid of peripheral reservoir 42, delivered by pumps 16B, 16C, are blended in outlet aperture 90 and are conveyed as far as distribution aperture 66 where the user can use them. The proportions of the two fluids depend on the respective volumes of pumps 16A, 16B, 16C. In the residual portion of the rotation as far as the indexed final position, the springs of the pump mechanisms push nozzles 54A, 54B, 54C, which cause plunger 38 to be raised as far as the upper position.

The description made in this manner of a pump cycle over a quarter revolution is preferably independent of the rotational direction of distribution head 22, which can be either direct or retrograde. To ascertain that the forces required to activate the pumps by direct or retrograde rotation are identical, guide track 80, on the one hand, and bottom 88 of guidance groove 86, on the other, have appropriate symmetries. In addition, there is nothing to prevent the user from always rotating distribution head 22 in the same direction, therefore over more than one revolution, where each quarter revolution corresponds to a pump cycle.

There are, of course, many possible modifications.

The number of pumps and reservoirs can vary. There can be two pumps, immersed in the same reservoir or in two separate reservoirs, which can be positioned symmetrically in relation to one another, either side of the reference axis, or where one is aligned with the reference axis and the other displaced. Implementations can also be envisaged with three pumps positioned at the apices of an equilateral triangle centred on the reference axis, or at the apices of an isosceles triangle one apex of which is aligned with the reference axis, as alternatives to the implementation with three coplanar pumps illustrated in the figures. Having more than one pump for a given reservoir firstly enables the dose delivered with a given translation stroke of plunger 82 to be increased, and secondly enables the forces on plunger 82 to be balanced.

The working strokes of the pumps can be identical or different. In this eventuality, it is possible, for example, that the plunger is securely coupled with the nozzle with the longest working stroke, and that the nozzles of the other pumps are installed sliding in the tubular sleeves 94A, 94B, 94C of the plunger.

Pump or pumps 16A, 16B, 16C can be attached to body 12 of distributor 10 by any appropriate means.

The general shape of body 12 of the distributor can vary. Distribution head 22 is, for its part, preferably cylindrical, but other choices can be made, in particular for a distribution head with a rotational symmetry of order N around reference axis 100, where N is a whole number, for example equal to the number of pump cycles obtained over one revolution of distribution head 22.

Pumps 16A, 16B, 16C can, if applicable, all be without air return. To this end, reservoir 42 may have a piston similar to piston 56, or each of pumps 16B, 16C may be immersed in a flexible pocket of variable volume. Bottom 44 of the base must then have openings to put the outer wall of the pocket or pockets of the piston under atmospheric pressure.

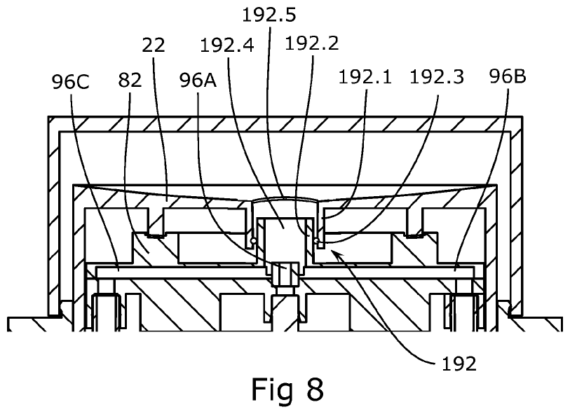

FIG. 8 illustrates, diagrammatically, a variant implementation of extensible channel portion 192 forming the connection between outlet 90 of distribution channels 96A, 96B, 96C and distribution aperture 66. Distribution head 22 comprises a cylindrical skirt 192.1 centred on reference axis 100, which protrudes towards plunger 82. The latter comprises a cylindrical drum 192.2 which protrudes towards distribution head 22, inside cylindrical skirt 192.1. A sealing joint 192.3, here illustrated diagrammatically as an O-ring, is attached to one of the two cylindrical elements 192.1, 192.2, in this case to cylindrical skirt 192.1, and presses, in sliding fashion, against the other cylindrical element, in this case cylindrical drum 192.2. An intermediate chamber 192.4 with a variable volume is thus delimited inside the two cylindrical elements 192.1, 192.2, between outlets 90 of distribution channels 96A, 96B, 96C and distribution aperture 66, closed by a membrane forming a non-return valve 192.5. The rotation of distribution head 22 causes a relative helical motion of both cylindrical elements 192.1, 192.2, combining rotation and translation. Sealing joint 192.3, sliding on cylindrical drum 192.2, provides the desired seal. In the first part of the distribution cycle, plunger 82 moves away from distribution head 22 and the volume of intermediate chamber 192.3 increases. In this phase the products are ejected from pumps 16A, 16B, 16C and are conveyed by distribution channels 96A, 96B, 96C into intermediate chamber 192.4, which they fill. Then, in the second part of the distribution cycle, plunger 82 moves closer to distribution head 22 and the volume of the intermediate chamber reduces. In this phase, the blend of products present in intermediate chamber 192.4 is gradually ejected through distribution aperture 22. For optimum operation, it is sought to make the volume of intermediate chamber 192.4 at the low position of plunger 82 greater than or equal to the sum of the volumes delivered by the three pumps 16A, 16B, 16C, such that the products are not ejected through distribution aperture 66 during the first phase of the distribution cycle. It is also sought to make the residual volume of intermediate chamber 192.4 as small as possible at the upper position of plunger 82, so as to ensure complete ejection of the products accumulated in intermediate chamber 192.4 at the end of the distribution cycle. To satisfy these requirements optimally, the diameters of cylindrical elements 192.1, 192.2, and the positioning of outlet aperture 90 in chamber 192.4, are modified.

It is explicitly stipulated that it is possible to combine the various illustrated or described implementations with one another in order to propose others.

It is emphasised that all the characteristics, as they can be deduced for a person skilled in the art from the present description, from the designs and from the attached claims, even if, in actual fact, they have been described only in relation with other determined characteristics, both individually and in any combinations, can be combined with other characteristics or groups of characteristics disclosed here, provided this has not been expressly excluded, or unless technical circumstances make such combinations impossible or meaningless.

1. Portable distributor (10) of several fluid or pasty products comprising:
a distributor body (12);
a distribution head (22) which can be rotated and which is not free to translate relative to the distributor body (12) around a reference axis (100) of the distributor, where the distribution head (22) comprises at least one distribution aperture (66), where the distribution aperture (66) is preferably aligned with the distributor's reference axis (100);
a pump assembly (14) comprising at least one first pump (16A, 16B, 16C) and at least one second pump (16A, 16B, 16C), where the first pump (16A, 16B, 16C) comprises a tubular nozzle (54A, 54B, 54C) defining a first ejection axis (200A, 200B, 200C) which is fixed relative to the distributor body (12) and parallel to the reference axis (100) of the distributor, the nozzle (54A, 54B, 54C) of the first pump (16A, 16B, 16C) is free to translate relative to the distributor body (12) parallel to the first ejection axis (200A, 200B, 200C), the second pump (16A, 16b, 16C) comprises a tubular nozzle (54A, 54B, 54C) defining a second ejection axis (200A, 200B, 200C) which is fixed relative to the distributor body (12) and parallel to the first ejection axis (200A, 200B, 200C), the nozzle (54A, 54B, 54C) of the second pump (16A, 16B, 16C) is free to translate relative to the distributor body (12) parallel to the second ejection axis (200A, 200B, 200C),
a kinematic connection (24) between the distribution head (22), and the nozzles of the first pump and of the second pump (54A, 54B, 54C), to transform a rotary motion without translation of the distribution head (22) relative to the distributor body (12) around the reference axis (100) of the distributor into a translational motion without rotation of the nozzles of the first pump and of the second pump (54A, 54B, 54C) relative to the distributor body (12) parallel to the distributor's reference axis (100), wherein the kinematic connection (24) comprises a plunger (82) interposed between the pump assembly (14) and the distribution head (22), the plunger (82) is connected to the distributor body (12) by a straight line linkage (58, 98) which can guide a translational motion without rotation of the plunger (82) relative to the distributor body (12), the plunger (82) is able to press on the nozzle (54A, 54B, 54C) of the first pump (16A, 16B, 16C) and on the nozzle (54A, 54B, 54C) of the second pump (16A, 16B, 16C) when the distribution head (22) rotates relative to the distributor body (12) around the distributor's reference axis (100), the plunger (82) comprises at least a first distribution channel (96A, 96B, 96C) to channel a first fluid being ejected from the nozzle (54A, 54B, 54C) of the first pump (16A, 16B, 16C) towards the distribution aperture (66), and a second distribution channel (96A, 96B, 96C) to channel a fluid being ejected from the nozzle (54A, 54B, 54C) of the second pump (16A, 16B, 16C) towards the distribution aperture (66).

2. Distributor (10) according to claim 1, characterised in that the kinematic connection (24) comprises an annular guide track (80) positioned at a constant distance from the distributor's reference axis (100), having one or more undulations, in an axial direction parallel to the distributor's reference axis (100), and an assembly of one or more sliding surfaces (88) cooperating with the annular guide track (80), where the annular guide track (80) and the assembly of one or more sliding surfaces (88) are designed such that rotation of the distribution head (22) around the distributor's reference axis (100) causes a relative translation between the annular guide track (80) and the assembly of one or more sliding surfaces (88) parallel to the distributor's reference axis (100), combined with a relative rotation between the annular guide track (80) and the assembly of one or more sliding surfaces (88) around the distributor's reference axis (100).

3. Distributor (10) according to claim 2, characterised in that the annular guide track (80) is continuous and enables a full revolution of the distribution head (22) to be made around the distributor's reference axis (100).

4. Distributor (10) according to either of claim 2 or 3, characterised in that the annular guide track (80) and the assembly of one or more sliding surfaces (88) are positioned such that the distribution head (22) can rotate around the distributor's reference axis (100) in a direct direction and in a retrograde direction, preferably over more than one revolution.

5. Distributor (10) according to any of the previous claims, characterised in that the distributor body (12) comprises:
a cylindrical guide surface which is radially turned towards the distributor's reference axis (100), and positioned level with a cylindrical guide surface of the distribution head (22) to guide the distribution head (22) rotationally around the distributor's reference axis (100) relative to the distributor body (12); and/or
a cylindrical guide surface which is radially turned away from the distributor's reference axis (100), and positioned level with a cylindrical guide surface of the distribution head (22) to guide the distribution head (22) rotationally around the distributor's reference axis (100) relative to the distributor's body (12).

6. Distributor (10) according to any of the previous claims, characterised in that the distributor's body (12) comprises:
an annular guide surface (72), which is preferably flat, axially turned away from the distribution aperture (66), level with an additional guide surface of the distribution head (22) and/or
an annular guide surface, which is preferably flat, axially turned towards the distribution aperture, level with an additional guide surface of the distribution head.

7. Distributor (10) according to any of the previous claims, characterised in that the first channel and the second channel comprise a channel portion (92, 192) which can be extended in a direction parallel to the reference axis (100).

8. Distributor according to claim 7, characterised in that the extensible channel portion (92, 192) of the first channel and the extensible channel portion of the second channel have a common outer casing.

9. Distributor according to claim 8, characterised in that the common outer casing comprises two cylindrical segments (192.1, 192.2) which can slide within one another parallel to the distributor's reference axis (100), and can rotate relative to one another around the distributor's reference axis (100), wherein one of the two cylindrical segments (192.1, 192.2) is fixed relative to the distribution head (22) and the other of the two cylindrical segments (192.1, 192.) is fixed relative to the plunger (82).

10. Distributor according to claim 8, characterised in that the common outer casing is a deformable wall (92), for example an accordion wall, having a first fixed end which is not free to translate relative to the distribution head (22), and a second fixed end which is not free to translate relative to the plunger (82).

11. Distributor according to any of claims 8 to 10, characterised in that the common outer casing comprises an annular sealing device (192.3) pressing against a gasket seat (192.2), and able, relative to the seal seat (192.2) when the distribution head (22) rotates relative to the distributor body around the reference axis (100).

12. Distributor (10) according to any of the previous claims, characterised in that the distributor body (12) comprises a wall (36) delimiting a peripheral reservoir (42) in which a pump body (52A, 52B, 52C) of one of the first and second pumps (16A, 16B, 16C) opens, where the other of the first and second pumps (16A, 16B, 16C) comprises a pump body (52A, 52B, 52C) which is immersed in another reservoir preferably held inside the peripheral reservoir.

13. Distributor (10) of fluid product according to any of the previous claims, characterised in that the pump assembly comprises at least one third pump (16A, 16B, 16C), comprising a tubular nozzle (54A, 54B, 54C) defining a third ejection axis (200A, 200B, 200C) which is fixed relative to the distributor body (12) and parallel to the first ejection axis (200A, 200B, 200C), wherein the nozzle (54A, 54B, 54C) of the third pump (16A, 16B, 16C) is free to translate relative to the distributor body (12) parallel to the third ejection axis (200A, 200B, 200C), wherein the plunger (82) is able to press on to the nozzle (54A, 54B, 54C) of the third pump (16A, 16B, 16C) when the distribution head (22) turns relative to the distributor body (12) around the distributor's reference axis (100) and comprises a third distribution channel (96A, 96B, 96C) to channel a fluid being ejected from the nozzle (54A, 54B, 54C) of the third pump (16A, 16B, 16C) towards the distribution aperture (66).

14. Distributor (10) according to any of the previous claims, characterised in that the distributor body (12) comprises one or more walls (28, 32, 44, 38) delimiting a reservoir (42) with a fixed volume into which opens at least one pump body (52B, 52C) of a pump (16B, 16C) in the pump assembly (14), where the wall or walls (28, 32, 44, 38) preferably comprise one or more outer walls (44, 22) of the distributor body (12).

15. Distributor (10) according to any of the previous claims, characterised in that the distributor (10) comprises at least one reservoir of variable volume (40) comprising at least one moving wall (56), in which a pump body (52A) of a pump (16A) in the pump assembly (14) is immersed.
